(19) United States
(12) Patent Application Publication
(10) Pub. No.: US 2017/0178262 A1
(43) Pub. Date: Jun. 22, 2017

(54) SYSTEM FOR PROMOTING AND MANAGING PROPERTIES UNDER JUDICIAL AUCTION

(71) Applicant: SISTEMIA S.P.A., ROMA (RM) (IT)

(72) Inventors: Alessandro FAUSTINI, ROMA (RM) (IT); Paolo SGRITTA, ROMA (RM) (IT)

(21) Appl. No.: 15/386,374

(22) Filed: Dec. 21, 2016

(30) Foreign Application Priority Data
Dec. 22, 2015 (IT) 102015000086538

(51) Int. Cl. G06Q 50/16; H04M 1/725; G06Q 30/08; H04W 4/02

(52) U.S. Cl. CPC G06Q 50/16; H04W 4/021; H04M 1/72522; H04M 1/7253; G06Q 30/08

(57) ABSTRACT

Disclosed is a technique for managing real estate judicial auctions providing real-time digital certification, with regard to the on-site inspections carried out by the involved subjects, on a certain date. The verification is carried out directly by using a combination of telecommunication units that performs: establishing the presence of the involved subjects, detecting the physical access thereof to a particular premises, by way of the geolocation function present on the devices for mobile telecommunications, possessed by those subjects; acquiring images and signatures through the telecommunications devices provided with video camera; georeferencing the acquisition of the images and all the operations that are submitted; encoding the content of the acquisition and adding a timestamp in order to allow the certification of the acquisition date of the data; and transferring the data acquired and made secure through telecommunication channels for preservation, consulting and logging at a dedicated data bank.

### TECHNICAL FIELD

The invention generally deals with a system for monitoring sales activities of properties under judicial auctions; in particular it refers to the procedures of certified verification of the visits and on-site inspections at a premises by interested subjects.

### STATE OF THE ART

It is known that in the real estate market, a large number of potential buyers do not participate at the judicial auctions relative to real estate properties. Those looking to buy a home are increasingly oriented towards contacting a real estate agency which is able to provide a wide range of possibilities in a given neighborhood and all the services required for finalizing the sale.

Consequently, for each real estate auction a sequence of auctions are executed, with base amounts progressively decreasing the long the home or the premises is without a buyer. All of this creates a series of disadvantages and problems:
the court must executed different hearings and auctions with subsequent price lowering, and this involves an extremely large work load;
on average, the banks see the value of the home that is the object of real estate execution fall 20-25%;
the procedures are also disadvantageous for the possible buyer: if he/she had been properly informed, he/she would participate at the auction, benefiting from a wider offer with a more varied selection of the purchasable properties;
finally, the same current owner does not see the home unit evaluated for the actual value.

It is clear that the dysfunctions derive from the fact that there is no network—such as that of real estate agencies—which proposes to a series of potential buyers the properties available for a certain zone. In general, it would suffice to ask the real estate agencies to work with these properties as well, with fair commission, and inform the possible buyer of the home units that can be purchased by means of judicial auction.

The further commission is made necessary since usually the real estate agency has no reason to work with the properties coming from real estate auctions, since it would not receive the typical compensation deriving from the mediation in the sale between private parties.

On the other hand, the real estate agency has the competencies for facilitating the sale of a home unit. Indeed, it is capable of providing a series of essential services: it would know to clearly explain to the possible buyer how the deposit works for participating at the auction, how to come into possession of a home unit if there is already an owner residing at the property, how to behave if there is a misuse not corrected. In substance, the real estate agent is the most suitable subject for facilitating the access of possible buyers to a real estate auction.

In summary, the current attempts to sell properties under judicial auctions have the following basic contradictions:
1—Deterioration of the value of the premises due to lack of participation and offers for properties at auctions.
2—Poor visibility of properties at auction, where there are many properties on sale and low demand.
3—Real estate agencies are currently not involved in the process of sale by means of judicial auctions.
4—Diffidence of buyers in purchasing at auction.
5—Agents and potential buyers (non institutional) have little knowledge of the purchase process at auction.

A system is known from some prior art patents that allows recording the meeting the took place online, by means of acquiring images and signatures of the people involved. However, such documents do not deal with the possible application to the real estate sector, which would require particular requirements and functional specifications with respect to more general applications.

The document JP 2004-253825 refers to a technique for remote communications that allows a group of people belonging, for example, to a board of directors, to be able to conduct strictly confidential meetings with due privacy. This technique provides for the use of instruments such as telecommunications and data transmission such as cell phone, telephone lines, instant messaging, Internet, video filming etcetera. The method also uses technologies of authentication and encrypting for identifying the right to vote of each person who has this prerogative and for preventing illegal actions in the voting management process.

The patent document CN 103856464 deals with a multi-authentication system relative to the information relative to the identify of a person based on the typical functions of the smartphone, which films the subject through the camera with which it is provided.

The system is used for recording the information relative to the identify card, such as first name, last name, address, age, sex, etcetera, as they are contained on the identify document, in order to conduct a verification and an identification of the subject.

The described technique provides an operating mode for authenticating the identity document that is extremely flexible and convenient for the platforms that work on the Internet.

However, these systems according to the prior art lack any reference to georeferencing, i.e. this type of online verification of the remote presence is not executed, taking as reference the particular place where the event occurred.

The object of the present invention is to provide a system for managing the real estate judicial auctions which eliminates or at least reduces the aforesaid disadvantages of the current property sales procedures.

A further object of the present invention is to provide means which allow overcoming the diffidence of potential buyers when they participate at a real estate auction.

Still another object of the present invention is to provide techniques for certification of the actual visit that took place on a premises by a specific person on a certain date, without the verification being carried out by using conventional third parties—such as public officials—but rather directly using suitable computer tools.

Finally, an object of the present invention is to provide techniques and control devices which employ operating systems and access and communication protocols that are among the most widespread and recognized as standards in the mobile telephone field, in order to make the achievement of the invention immediate, reliable and easy to manage and maintain.

The above-listed objectives are obtained by means of a new principle for managing real estate judicial auctions as stated in claim 1.

### BRIEF DESCRIPTION OF THE DRAWINGS

Only in order to better clarify the invention and without wishing to limit the scope thereof and the fields where it can have application, several particular embodiments will be described hereinbelow, also with reference to the enclosed drawings:

FIG. 1 is an overall block diagram of the operation of the management system according to the present invention;

FIG. 2 is a detailed block diagram of the operation of the management system according to the present invention;

FIG. 3 is a block diagram that reports a particular aspect of the solution according to the present invention;

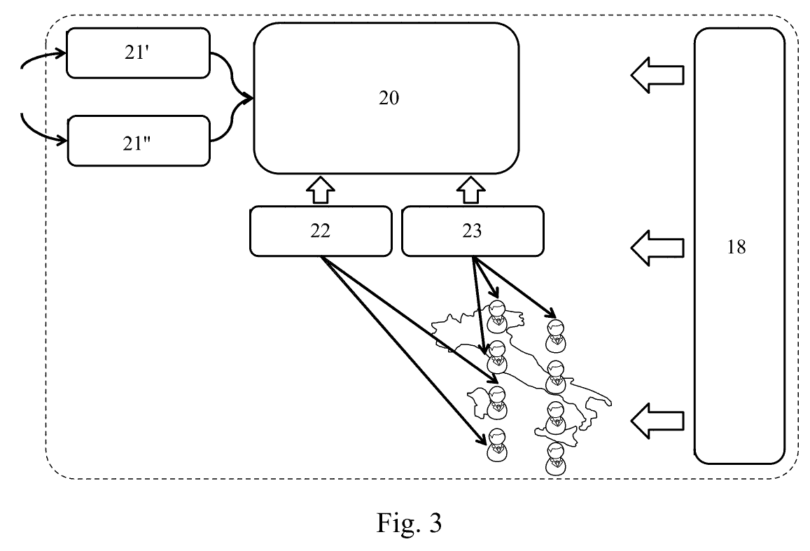

FIG. 4 is a block diagram of the functional hardware configuration of a particular apparatus employed in the technique according to the present invention.

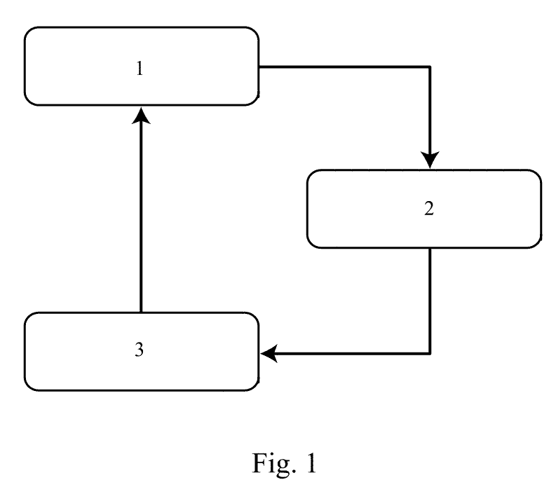

FIG. 1 is a general diagram illustrating how the system for managing real estate judicial auctions according to the invention allows attaining the pre-established objects. In step 1, the procedures for the targeted marketing of the properties at auction are executed. Then, the dedicated procedures provide the specialized support for the participation at the auctions and sale in step 2. Then, in step 3, there is the updating, tracing and reporting for the participations and the sales. Such operating step reports feedbacks to the targeted marketing step 1, which on the basis of the acquired parameters provides the means for the subsequent reset of the entire process of sales of the properties at auction to potential buyers through the network of the agents present in the field.

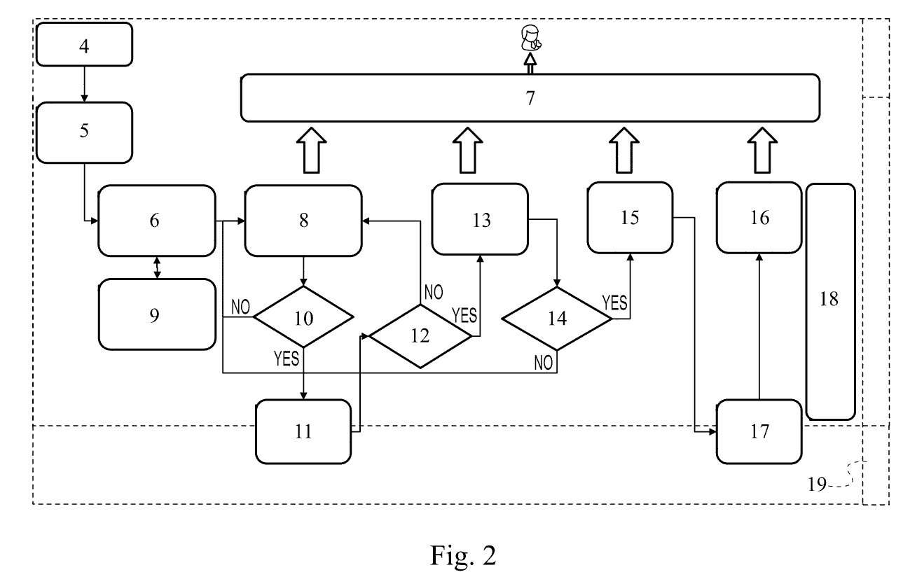

FIG. 2 is a more detailed representation by means of block diagrams of the process, end to end, for managing the sale of the properties at auction to potential buyers through the network of the agents present in the field. Highlighted in such representation are respectively the interface with the client 7, the control center 18 and the actual buyer 19. Starting from the flow 4 of data and documents of the client, a real estate properties card 5 is initially created with a standard format that serves for the population 6 of the data bank of the real estate portal and for the creation of the announcement for sale. Such announcement is synchronized in step 9 with all the announcements currently operative on the managed network. Then one passes to step 8 to the activities of client search for single properties with targeted campaigns in the scope of the implemented network. Then, in step 10, the buyer can directly request to visit the premises; and then in step 11 there is the actual visit with the assistance of an agent. In accordance with the outcome of the visit 12, such result is reported in the search activities 8 or the portal 13 is updated with the tracking of the visit itself. At this point, in step 14, the buyer is requested to possibly participate at the auction, after which the updating 15 of the portal would take place along with the tracking of the relative participation at the auction. After the participation at the auction 17, there is the consequent tracking 16 of the auction results.

The targeted marketing step is the object of acquisition 21′ of the structured data which is digitized in step 21″ in a suitable data bank through the portal 20 of the control center 18, at which a call center 22 and a management system 23 are operating for the campaigns georeferenced over the entire national territory. The control center 18 intervenes in real time on the operations of such apparatuses, being based on its own technical, administrative and legal support. In particular a series of dedicated competencies are provided, such as:
Continuous education for purchases at auction
Legal and administrative support
Technical support
Continuous formation of agency networks for purchasing properties by means of judicial auctions
Knowledge Sharing methods and instruments for growing knowledge through experience

With regard to the monitoring and reporting carried out by the control center 18, the following activities are also proposed:
Online updating of the portal properties at the auction
Tracking visits to properties
Tracking participation at auction (tracking negotiation originator)
Analytical reporting for activity advancement analysis for operating service management
Directional analytical reporting with client visibility

As stated above, there is also the need to verify and certify the actual visit made to a property by a specific subject on a certain date. The verification is not undertaken by using conventional third parties such as public officials who certify the identify of a subject and the presence at a specific site, but rather by directly using suitable computer tools that ensure the low cost of the operation and the data transmission speed. The solution provides for the use of a combination of mechanisms suitable for allowing a certain verification. The employed mechanisms consist of:
1. an application SW which the interest subject downloads on cell phone or smartphone 67; the physical access to a particular premises automatically ensures, by means of the App and the geolocation function present on the smartphone, that the subjects involved in a visit are automatically found within a group of people present at the “site” and then the presence in that given instant is recorded;
2. acquiring images and signatures through devices provided with video camera and devices touch screen;
3. georeferencing the acquisition of the images and in general of all the operations that are submitted;
4. encoding the content of the acquisition and adding a timestamp provided by an external authority in order to allow the certification of the acquisition date of the data;
5. transferring the data acquired and made secure to the portal 20 of the control center 18, through telecommunication channels for preservation, consulting and logging.

The above-described characteristics are present in their entirety and not alternatively.

Such signature/film is preserved in the dedicated database 20 of the central system 18, as a document that strengthens the negotiation and that is transmitted to the bank to attest the visit executed by the interested client. In this manner, the tracking of the visits to the premises to be sold at auction is implemented.

A particular embodiment of the remote recording procedure is based on a sequence of pre-established steps for the authentication of the on-site inspection that took place, based on the digital mobile device 67 possessed by of each of the involved subjects in the visit to the premises. It is assumed that the smartphone is provided with a webcam or with a digital camera and can be connected to the dedicated service center at the control station 18. The operating steps provide that:
through the geolocation device present on the smartphone, the subjects involved in the visit are automatically found within a group of people present at the “site”, then the presence thereof at said site at a certain time and date is recorded;
a valid recognition document is exhibited, to be used in the authentication process;
the charged subjects frame the recognition document to be used in the recording, taking possible front/back photographs to be sent to the enabled operator of the service center 20;
the service center 20 verifies the exhibited document with the operator on duty, (in particular the document exhibited by the possible buyer), through comparison with that filed at the same control center 18 in order to verify the identity thereof;
in case of success, a recording session is started by means of video-conference between portal of the service center 20 and site of the premises at which the on-site inspection is being executed;
at the end of the on-site inspection, the recorded video film relative to the meeting that took place is transmitted and stored, with preservation of the files containing such videos and films of the meeting in a dedicated data bank (20).

Such application types provides for the implementation of further dedicated procedures. In particular, specific proprietary maps have also been made; each map is dedicated to a home unit. Then, the user is provided with the maps of the home units of interest, and by zooming on each map he/she will first be able to see the roads surrounding the premises, then see the home unit from the outside and then progressively enter into the home unit itself in order to visit the layout of the spaces thereof. A client retention strategy is thus implemented: the client, using effective and reliable tools, becomes confident of service quality.

As stated above, it is provided that the agencies involved in the described solution receive a fair commission. For such purpose, a “rating” parameter is defined: within a list of real estate properties, object of judicial auction, the rating constitutes the element that allows providing an index of priority for the operating activities (priority management as a function of the rating) and a search criterion for displaying the real estate properties. The novelty of the algorithm is represented by the dimensions that are used for the construction of the rating and by the combination of typically static dimensions such as those relative to the real estate property (sale value and evaluation value, geographic zone) with dynamic dimensions tied to the evidence of perceived interest. In particular, the solution provides for the use of an evaluation and rating algorithm which uses the following dimensions:
1. Value of the real estate property at auction/technical expert estimate value
2. Real estate property category/class
3. Location zone of the real estate property
4. Finish of the real estate property
5. Occupation state
6. Visit frequency of the display page
7. Level of interest

In addition—still with the goal stimulating the loyalty of the potential buyer by means of real estate auction by offering a completely free technical consulting service which is manifested in multiple areas—a particular function has been created for detecting the quality of the air and the acoustic/electromagnetic pollution present in a specific urban zone, where data is compared with the detections made over sufficiently long time periods. In fact, it is certainly of interest to the potential buyer to know if the property site suffers air pollution or if it is situated in a particularly chaotic zone.

The possible buyer is in this manner capable of autonomously controlling the healthiness of the environment where he/she would go to live. At the same time, he/she receives a parallel path that increases the redundancy and the reliability of the recording online.

For this reason, in the particular embodiment of the present invention, environmental parameter monitoring stations 64 are provided, arranged in proximity to the home, object of sale. Such stations have the function of continuously detecting and recording parameters such as:

a— pollution from CO2 or another pollutant of chemical type, such as particulate, volatile organic compounds, etc.;
b— noise pollution deriving from traffic or from workshops present in the zone, both during the day and at night;
c— electromagnetic pollution;
d— hydrometeorological environmental parameters such as temperature, wind and humidity, etc.

These are environmental monitoring stations that are installed in proximity to the home unit, object of real estate auction, in a manner so as to detect a series of data useful for the possible buyer. The latter can know the type of home that he/she is about to purchase and the relative environmental position.

The installation of such units occurs anonymously, as they have the external appearance of a telephone control unit or a power distribution station. The detection and recording stations provide for a door that is opened with a key or a digital code. Access is allowed to the employees of the management system or even to the possible buyer. In fact the latter has the possibility to read the data recorded on the resident memories 50, 53, through a dedicated display 60 and/or a printer of the control unit 64.

At the same time, the buyer can test the veracity of the acquired data. In fact the control station 18, through the specific real estate agency, provides the possible buyer with dedicated devices that allow evaluating the objective operations and veracity of such results. This is based on several low-cost, innovative solutions. Devices designed for transforming the smartphone into an environmental monitoring station are already known. For example, the Sensordrome is capable of recording environmental humidity levels, carbon monoxide, particulates, light density, VOC pressure and other factors. Another device is the Kit Lapka, which is capable of detecting the pollution, if interfaced with an iPhone, being connected through the relative earphone jack.

The sensors present in these devices measure the temperature, environmental humidity, electromagnetic radiations, etc. Hence, it is possible, also for the possible buyer of the home unit, to receive an immediate feedback regarding the veracity of the data that the control unit records through the installed HW. The object is still to instill trust in the buyer so that he/she will purchase by means of real estate auction, offering a technical consulting service that can be tested in real time at the site where the property is situated. In substance, the user is provided with the possibility to test—with a significant margin of assurance—the veracity of the acquired data. It is as if he/she himself/herself were following the acquisition and recording of the environmental data; in this manner, he/she knows with certainty the environmental qualities of the home he/she is about to purchase and above all he/she is reassured regarding the quality of the service offered in purchasing the premises by means of judicial auction.

In a different embodiment of the present invention, it is provided that the acquired data is periodically transmitted to the portal 20 situated at the control center 18, where such data is then processed and provided on reports, possibly with graphs. The transmission between the detection station 64 and the collection unit 20, at the control center 18, is carried out via landline public phone or mobile phone. In particular the control unit 64 is connected to the central server 18 by means of a ADSL or GPRS network, arranging and initializing a gateway 55 set for communications inside the monitoring station 64. If the communication occurs intermittingly, the gateway is provided with an internal transit memory 56 capable of locally recording the data that cannot be sent immediately to the server 18, in order to then restart the transmission when the same is restored. The usual operating systems such as Linux and Windows are available for managing the acquisition and the transmission of the data. An offline processing of the data is also provided at the control center 18, with possible reports that are consulted by the buyer when he/she makes a selection on the home of interest.

The automatic stations 64 with considerably low power consumption, have the function of measuring, processing and archiving the data relative to the environmental parameters. Each station 64 functions in an entirely autonomous manner, displaying the data on the LCD display 60, archiving it and recording it on an internal memory 53.

Inside the main container, the low voltage power supply part is housed; the entire electronic part of the station is housed in a second internal container.

The use of CMOS components and the auto-off software techniques allow drastically reducing power consumptions. The control unit is thus easily supplied with power in an entirely autonomous manner, with a small photovoltaic panel and buffer battery to ensure the autonomy in dark nocturnal periods and times of poor daily insolation.

The main components are the microprocessor electronics CMOS on a card, RAM memories 50, Eprom 51 and mass memories on a hard disk 53, a control and display panel 60, as well as a real time clock 52.

It is possible to connect n sensors of analog type under current, under voltage or of thermistor type.

In particular, among the sensors, detection sensors are provided for detecting the acoustic pollution 54 which provide for the presence of a phonometer of standard type. More particularly, class 1 integrator phonometers are preferred which are able to carry out the continuous integration over time of the sound level and then provide, in addition to the instantaneous pressure value, also all the parameters necessary for the noise analysis.

Such parameters are provided at the input with a spectrum analyzer, which allows an in-depth analysis of the frequency distribution of the noise. The analyzer is provided with digital filters that separate the entering signal into its frequency components, dividing it into octave or one-third octave bands. The analysis is simultaneously made over all the bands so as to be able to view, in real time, how the sound spectrum varies over time.

A series of dedicated sensors 57 are then provided for carrying out various types of monitoring of the air in the environment, along with air-dispersed pollutants. The conduct the monitoring of the main pollutants present in the urban environment and regulated according to precise laws. In particular, the monitored pollutants are the following: NO2, NX, O3, SO2, CO, benzopyrene, PTS, (H2SNO), heavy metals, volatile organic compounds, etc.

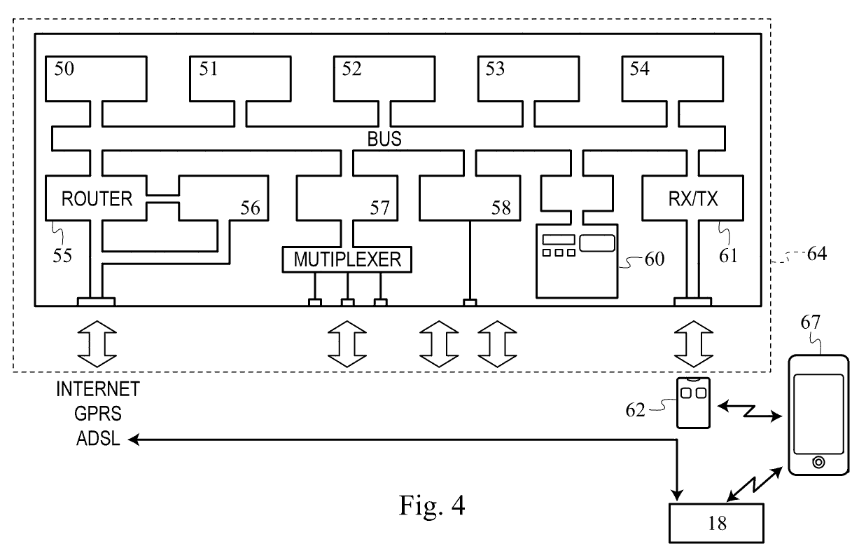

The environmental monitoring is also executed with regard to the electromagnetic pollution deriving from the installation of telecommunications antennae or another RF apparatus nearby. In particular, the diagram reported in FIG. 4, such function is carried out by the sensor 58.

Beyond the hardware and software constitution of the control unit, the mode of access by users—there can certainly be more than one—is particularly original.

Indeed, on one hand, the control unit 64 has the particular characteristic that the buyer feels that he/she himself/herself is managing and controlling the activity of the detection station, when instead he/she can only read the data contained in the control unit itself.

On the other hand, the control station 18, through the agencies, proposes the home unit to different possible buyers. Each of these must be recognized by the recognition system residing on the control unit, and each of these must be granted an access following recognition. For such purpose, portable electronic device 62 is provided, independent, which could also be configured as a cover for the smartphone itself. It comprises its own power supply which allows the transmission both over specific frequencies—such as at 433.92 Mhz, normal for gate-opener remote controls—and with Bluetooth protocol. The remote control transmission serves for being interfaced with the acquisition station 64, being based on a particular identification code of the device 62, while the Bluetooth transmission serves for indicating its presence to the cell phone 67 possessed by the user. In practice, the two-channel device 62 appears as an interface between a smartphone and a control unit or another dedicated peripheral unit.

Hereinbelow, the procedures for activating and optimizing the provided service will be described in detail.

Before being able to use the application dedicated for the use of the portable device 62, it is necessary to activate the Bluetooth on the smartphone 67. Then, in order to associate the devices to be monitored, the first operation to be executed is an initialization that selects the monitoring of only the acquisition stations of interest. In order to carry out this operation, it is necessary to launch the application from the main menu of the smartphone. Once the device 62 is detected by the smartphone 67, the procedures of connection of the new device 62 are actuated.

Then, once the device 62 is detected and selected, a procedure is initiated for attributing the identification of the possible buyer subject. The combination occurs by associating the identification of the subject and the identification of the relative device 62 with the smartphone 67.

This combination constitutes a further mode, during a visit at the premises, to readily certify the presence of the different interested subjects. Indeed, the device 62 and smartphone 67 combination itself becomes a unique identification attesting the presence of the person in a given place and at a given instant. The technique of remote certification in this case is no longer based on the detection of the image of the identity document, but rather the detection of the recognition device 62 is sufficient, possessed by each of the involved subjects in the visit to the property. The functions of the webcam or a digital camera with connection to the dedicated service center 20, at the control station 18, remain essential for the filming of the meeting and the subsequent storage.

In this case, the verification by the service center can occur automatically, without the intervention of the relative operator who controls the exhibited document. It is sufficient that the procedure carry out the control of the correspondence between the code stored in the transceiving device 62 and the cell phone number and number of the control unit, as this three-part correspondence is stored at the data bank of the service center 20. Such correspondence between codes occurs in real time and is communicated to the subjects who are presently at the on-site inspection underway at the premises.

In particular, the specific redundant signaling function is indicated in order to execute the recording, online. In other words:
on one hand recording of the meeting with all the participants present can be carried out by employing the usual means already possessed by the user, in particular on the basis of the use of a smartphone that films the identity document and relative photograph for a comparison at the service center;
on the other hand, an alternative solution is identified for the certification and recording of the on-site inspection/visit that makes use of proprietary means such as the control unit 64 with RXTX section 61 and relative transmission device 62 possessed by the user.

The possibility of operating with two separate processes of authentication allows having greater security regarding the certification that took place of the presence of the interested subjects.

Therefore, from this standpoint, this is a security system in which the reliability is ensured by the redundancy of the components and by the diversification of the components of the system.

Indeed, according to this second preferred implementation, initially it is the single user who marks his/her presence by activating the connection of the device 62 with the control unit 64. Simultaneous with such indication, he/she sends, through the Bluetooth, the signaling of his/her presence (and of the alert sent to the control unit) to the cell phone 67. The App residing herein provides for recording the signaling that occurred and the presence on the site of the subject associated with a specific cell phone 67/device TX 62 identification.

Following the reception of the signaling, the control unit itself provides for communicating, to the control center 18, the presence on the site of the particular subject interested in purchasing. The control center will send an acknowledgement—such as an SMS—to the phone 67 of the interested subject, which confirms the communication that took place. There is also a control unit 64 installed ad hoc in proximity to each premises, object of auction, and it allows operating with a device 62 in order to inform the user that he/she has been recognized and that he/she can continue with the on-site inspection underway.

The different type of implemented authentication is thus clear—this does not require the recognition of photographs or documents, but rather is based on the introduction of a new device, possessed by the user.

At the end of the on-site inspection, it is also provided to store the recorded video clip relative to the meeting that took place, with preservation of the files containing such videos and films of the meeting in the buffer of the control unit 64, if the direct connection to the database of the service center is not ensured. In this case, there is Bluetooth connection with the RXTX station 61 of the monitoring station.

Finally, it should be indicated that the use of the device 62 allows operating in an extremely effective manner in managing the users. For example, in order to exclude one or more devices 62 from the monitoring, after having entered into the main screen of the application, the Setting functions are activated along with the list of all the associated devices. Those devices currently included in the monitoring will have an active indication next to the name, while those excluded will have a deactivated indication. From here, one proceeds with the selection of the device to be excluded. The high flexibility of the application should be indicated, as it allows operating with N devices with activations/deactivations actuatable in real time.

### ADVANTAGES AND INDUSTRIAL APPLICABILITY OF THE FINDING

The advantages of the described system are evident:
Involving the sales networks in promoting the properties at the auction, as is done for properties in classical sales systems. This in order to increase the number of buyers (increase the demand)
Increasing the buyer's trust in purchasing by means of real estate auctions, by offering a completely free technical and legal consulting service
Introducing an incentive model, implemented for real estate agencies, as a lever in the field for sales promotion
Providing the necessary consulting so as to be able to assist agents in the field and potential buyers in remedying the little knowledge of the purchase process at auction.

1. Technique for managing real estate judicial auctions that provides for a digital certification, in real time, of an on-site inspection carried out at a premises by the involved subjects, on a certain date, the verification being carried out directly by using a combination of telecommunication means suitable for allowing a secure verification through the following operating steps:
a. establishing the presence of n subjects involved, for a certain time period, in a given place, detecting the physical access thereof to a particular premises, by means of the function of geolocation present on the devices for mobile telecommunications (67), possessed by the same subjects involved in the visit who are automatically inserted in a group or people present at the “site”, then recording the participation at the event;
b. acquiring images and signatures through the telecommunications devices (67) provided with video camera and input by means of a touch screen;
c. georeferencing the acquisition of the images and all the operations that are submitted;
d. encoding the content of the acquisition and adding a timestamp provided by an external authority in order to allow the certification of the acquisition date of the data;
e. transferring the data acquired and made secure through telecommunication channels, for preservation, consulting and logging at a dedicated data bank (20), resident at a service center of a control station (18).

2. Technique for managing real estate judicial auctions according to claim 1 wherein for the transmission in real time of the images relative to the on-site inspection underway, by means of the device for mobile telecommunications (67) provided with a webcam or with a digital camera, one executes the connection to the dedicated service center at the control station (18), the filming of said images providing that:
I—a valid recognition document is exhibited, to be used in the authentication process;
II—the charged subjects frame the recognition document to be used in the recording, taking possible front/back photographs to be sent to the enabled operator of the service center (20);
III—the service center (20) verifies the exhibited document with the operator on duty, through comparison with that filed at the data bank, at the same service center (20), in order to verify the identity thereof;
IV—in case of success of the verification III, a session is started for transmission and recording by means of video-conference between the portal of the service center (20) and site of the premises at which the on-site inspection is being executed;
V—at the end of the on-site inspection, the recorded video film relative to the meeting that took place is stored, with preservation of the files containing such videos and films of the meeting in the dedicated data bank at the service center (22).

3. Technique for managing real estate judicial auctions according to claim 1, wherein intermediary subjects in the sales process receive a fair commission based on a rating parameter which, within a list of real estate properties, object of judicial auction, allows providing both an index of priority for the operating activities and a search criterion for displaying the real estate properties, said rating parameter being based on the combination of typically static dimensions such as those relative to the real estate property—sale value and evaluation value, geographic zone—with dynamic dimensions tied to the evidence of perceived interest.

4. Technique for managing real estate judicial auctions according to claim 3, further providing for the use of an evaluation and rating algorithm which uses the following dimensions:
i. value of the real estate property at auction/technical expert estimate value,
ii. real estate property category/class,
iii. location zone of the real estate property,
iv. finish of the real estate property,
v. occupation state,
vi. visit frequency of the display page,
vii. level of interest.

5. Technique for managing real estate judicial auctions according to claim 1, wherein the technique uses environmental monitoring stations (64) which are installed in proximity to the premises, object of real estate auction, so as to provide, to a potential buyer, particular functions of detection of the quality of the typical environmental conditions of a specific urban zone, the possible buyer subject being able to autonomously control, by means of the aforesaid monitoring station (64), the healthiness of the environment in which he/she would come to live and at the same time providing, by means of the aforesaid monitoring stations (64), a parallel path which increases the redundancy and the reliability of the digital certification procedures in real time, in completing a visit and/or an on-site inspection at a premises.

6. Technique for managing real estate judicial auctions according to claim 1, wherein the control station (18), through intermediary subjects, proposes the home unit to multiple possible subjects interested in purchasing, each of the latter being recognized by the recognition system resident on the monitoring station (64) and each of these being allowed an access to data following recognition, said recognition occurring by means of a portable electronic device (62), independent, which is released by the control station (18) with an identification thereof and allows the transmission both on specific work frequencies and with Bluetooth protocol,
said remote control transmission being used for interfacing with the acquisition station (64), and
said Bluetooth transmission being used for ensuring that the cell phone (67) possessed by the user detects the presence of the device (62).

7. Technique for managing real estate judicial auctions according to claim 1, wherein the combination between the code of the two-channel device (62) and telephone number of the device for mobile telecommunications (67) constitutes one mode, during on-site inspection at the premises, of securely and immediately certifying the presence of each interested subject, the combination between the two-channel device (62) and the device for mobile telecommunications (67) constituting a unique authentication identification of the presence of the person in a given place for a certain time, with the procedure of remote certification of the on-site inspection that took place, in this case regardless of the detection of the image of the identity document,
the verification by the service center automatically occurring,
a—with the sending, on a dedicated channel of a first landline or mobile telephone line (55), of the code stored in the transceiving device (62) with the cell phone number (67) and with the identification of the monitoring station (64), to the service center (20),
b—with the execution of the control of the correspondence between the code stored in the transceiving device (62), with the cell phone number (67) and with the identification of the monitoring station (64), and this three-part correspondence is stored at the data bank of the service center (20), and
which, in case of success of the verification b), is followed by the filming of the meeting and the subsequent storage, based on the functions of the webcam or of a digital camera of the device for mobile telecommunications (67) which when connected to the dedicated service center (20), at the control station (18), executes the transmission on a second channel of the public telephone mobile line with the storage, at the end of the on-site inspection, of the recorded video relative to the meeting that took place, and with the preservation of the files containing such videos and films of the meeting in a dedicated data bank (20).

8. Technique for managing real estate judicial auctions according to claim 7, wherein the preliminary control of the correspondence between code stored in the transceiving device (62), with the cell phone number (67) and with the identification of the monitoring station (64), occurs in real time, the outcome being simultaneously communicated to the subjects who are about to begin the on-site inspection at the premises.

9. Technique for managing real estate judicial auctions according to claim 1, further providing specific proprietary maps to the device for mobile telecommunications of each subject, potential buyer, each map being dedicated to a real estate property, it being possible to view in such maps, via zoom, the roads surrounding the premises, then see the building unit from the outside with the relative monitoring station (64) and then progressively enter into the building unit itself in order to visit the layout of the spaces thereof.

10. Apparatus for managing real estate judicial auctions according to claim 1 wherein the apparatus uses devices (67) for mobile telecommunications with relative web camera or camera that communicate over the public telephone network and is based on the installation of environmental monitoring and detection stations (64) comprising:
a—microprocessor electronics on a card,
b—RAM (50), Eprom (51) memories and mass memories on hard disk (53),
c—a control and display panel (60),
d—N sensors (57) of environmental parameters,
e—sensors for detecting the sound pollution (54) and electromagnetic pollution (58),
f—transmission unit (55) over public mobile telephone network or over landline,
further comprising:
g—in the same detection and acquisition station (64), a RXTX section (61) for local communication with:
h—a portable electronic device (62), independent, comprising its own power supply that allows the transmission both over specific frequencies and with Bluetooth protocol,
said two-channel device (62) operating as an interface between the device for mobile telecommunications (67) and the control unit (64) or another dedicated peripheral unit,
the transmission, e.g. remote control, allowing the interfacing with the acquisition station (64), being based on a particular identification code of the device (62), while
the Bluetooth transmission serving for ensuring that the cell phone (67) possessed by the user detects the presence of the device (62).

11. Technique for managing real estate judicial auctions according to claim 2, wherein intermediary subjects in the sales process receive a fair commission based on a rating parameter which, within a list of real estate properties, object of judicial auction, allows providing both an index of priority for the operating activities and a search criterion for displaying the real estate properties, said rating parameter being based on the combination of typically static dimensions such as those relative to the real estate property—sale value and evaluation value, geographic zone—with dynamic dimensions tied to the evidence of perceived interest.

12. Technique for managing real estate judicial auctions according to claim 2, wherein the technique uses environmental monitoring stations (64) which are installed in proximity to the premises, object of real estate auction, so as to provide, to a potential buyer, particular functions of detection of the quality of the typical environmental conditions of a specific urban zone, the possible buyer subject being able to autonomously control, by means of the aforesaid monitoring station (64), the healthiness of the environment in which he/she would come to live and at the same time providing, by means of the aforesaid monitoring stations (64), a parallel path which increases the redundancy and the reliability of the digital certification procedures in real time, in completing a visit and/or an on-site inspection at a premises.

13. Technique for managing real estate judicial auctions according to claim 3, wherein the technique uses environmental monitoring stations (64) which are installed in proximity to the premises, object of real estate auction, so as to provide, to a potential buyer, particular functions of detection of the quality of the typical environmental conditions of a specific urban zone, the possible buyer subject being able to autonomously control, by means of the aforesaid monitoring station (64), the healthiness of the environment in which he/she would come to live and at the same time providing, by means of the aforesaid monitoring stations (64), a parallel path which increases the redundancy and the reliability of the digital certification procedures in real time, in completing a visit and/or an on-site inspection at a premises.

14. Technique for managing real estate judicial auctions according to claim 4, wherein the technique uses environmental monitoring stations (64) which are installed in proximity to the premises, object of real estate auction, so as to provide, to a potential buyer, particular functions of detection of the quality of the typical environmental conditions of a specific urban zone, the possible buyer subject being able to autonomously control, by means of the aforesaid monitoring station (64), the healthiness of the environment in which he/she would come to live and at the same time providing, by means of the aforesaid monitoring stations (64), a parallel path which increases the redundancy and the reliability of the digital certification procedures in real time, in completing a visit and/or an on-site inspection at a premises.

15. Technique for managing real estate judicial auctions according to claim 2, wherein the control station (18), through intermediary subjects, proposes the home unit to multiple possible subjects interested in purchasing, each of the latter being recognized by the recognition system resident on the monitoring station (64) and each of these being allowed an access to data following recognition, said recognition occurring by means of a portable electronic device (62), independent, which is released by the control station (18) with an identification thereof and allows the transmission both on specific work frequencies and with Bluetooth protocol,
said remote control transmission being used for interfacing with the acquisition station (64), and
said Bluetooth transmission being used for ensuring that the cell phone (67) possessed by the user detects the presence of the device (62).

16. Technique for managing real estate judicial auctions according to claim 3, wherein the control station (18), through intermediary subjects, proposes the home unit to multiple possible subjects interested in purchasing, each of the latter being recognized by the recognition system resident on the monitoring station (64) and each of these being allowed an access to data following recognition, said recognition occurring by means of a portable electronic device (62), independent, which is released by the control station (18) with an identification thereof and allows the transmission both on specific work frequencies and with Bluetooth protocol,
said remote control transmission being used for interfacing with the acquisition station (64), and
said Bluetooth transmission being used for ensuring that the cell phone (67) possessed by the user detects the presence of the device (62).

17. Technique for managing real estate judicial auctions according to claim 4, wherein the control station (18), through intermediary subjects, proposes the home unit to multiple possible subjects interested in purchasing, each of the latter being recognized by the recognition system resident on the monitoring station (64) and each of these being allowed an access to data following recognition, said recognition occurring by means of a portable electronic device (62), independent, which is released by the control station (18) with an identification thereof and allows the transmission both on specific work frequencies and with Bluetooth protocol,
said remote control transmission being used for interfacing with the acquisition station (64), and
said Bluetooth transmission being used for ensuring that the cell phone (67) possessed by the user detects the presence of the device (62).

18. Technique for managing real estate judicial auctions according to claim 5, wherein the control station (18), through intermediary subjects, proposes the home unit to multiple possible subjects interested in purchasing, each of the latter being recognized by the recognition system resident on the monitoring station (64) and each of these being allowed an access to data following recognition, said recognition occurring by means of a portable electronic device (62), independent, which is released by the control station (18) with an identification thereof and allows the transmission both on specific work frequencies and with Bluetooth protocol,
said remote control transmission being used for interfacing with the acquisition station (64), and
said Bluetooth transmission being used for ensuring that the cell phone (67) possessed by the user detects the presence of the device (62).

19. Technique for managing real estate judicial auctions according to claim 2, wherein the combination between the code of the two-channel device (62) and telephone number of the device for mobile telecommunications (67) constitutes one mode, during on-site inspection at the premises, of securely and immediately certifying the presence of each interested subject, the combination between the two-channel device (62) and the device for mobile telecommunications (67) constituting a unique authentication identification of the presence of the person in a given place for a certain time, with the procedure of remote certification of the on-site inspection that took place, in this case regardless of the detection of the image of the identity document,
the verification by the service center automatically occurring,
a—with the sending, on a dedicated channel of a first landline or mobile telephone line (55), of the code stored in the transceiving device (62) with the cell phone number (67) and with the identification of the monitoring station (64), to the service center (20),
b—with the execution of the control of the correspondence between the code stored in the transceiving device (62), with the cell phone number (67) and with the identification of the monitoring station (64), and this three-part correspondence is stored at the data bank of the service center (20), and
which, in case of success of the verification b), is followed by the filming of the meeting and the subsequent storage, based on the functions of the webcam or of a digital camera of the device for mobile telecommunications (67) which when connected to the dedicated service center (20), at the control station (18), executes the transmission on a second channel of the public telephone mobile line with the storage, at the end of the on-site inspection, of the recorded video relative to the meeting that took place, and with the preservation of the files containing such videos and films of the meeting in a dedicated data bank (20).

20. Technique for managing real estate judicial auctions according to claim 3, wherein the combination between the code of the two-channel device (62) and telephone number of the device for mobile telecommunications (67) constitutes one mode, during on-site inspection at the premises, of securely and immediately certifying the presence of each interested subject, the combination between the two-channel device (62) and the device for mobile telecommunications (67) constituting a unique authentication identification of the presence of the person in a given place for a certain time, with the procedure of remote certification of the on-site inspection that took place, in this case regardless of the detection of the image of the identity document,
the verification by the service center automatically occurring,
a—with the sending, on a dedicated channel of a first landline or mobile telephone line (55), of the code stored in the transceiving device (62) with the cell phone number (67) and with the identification of the monitoring station (64), to the service center (20),
b—with the execution of the control of the correspondence between the code stored in the transceiving device (62), with the cell phone number (67) and with the identification of the monitoring station (64), and this three-part correspondence is stored at the data bank of the service center (20), and
which, in case of success of the verification b), is followed by the filming of the meeting and the subsequent storage, based on the functions of the webcam or of a digital camera of the device for mobile telecommunications (67) which when connected to the dedicated service center (20), at the control station (18), executes the transmission on a second channel of the public telephone mobile line with the storage, at the end of the on-site inspection, of the recorded video relative to the meeting that took place, and with the preservation of the files containing such videos and films of the meeting in a dedicated data bank (20).
